(19) United States
(12) Patent Application Publication
(10) Pub. No.: US 2005/0057640 A1
(43) Pub. Date: Mar. 17, 2005

(54) Compact material marking system and method

(75) Inventors: David Clarke, Mukilteo, WA (US); John R. Wheeler, Kirkland, WA (US); Philip A. Wrobel, Mukilteo, WA (US); Jeffrey P. Symbol, Bellevue, WA (US); Jeffrey M. Warren, Lynnwood, WA (US); Raymond L. Silta, North Bend, WA (US); Peter J. Hougardy, Lake Stevens, WA (US)

Correspondence Address: DARBY & DARBY P.C., P. O. BOX 5257, NEW YORK, NY, 10150-5257, US

(73) Assignee: Synrad, Inc., Mukilteo, WA (US)

(21) Appl. No.: 10/654,597

(22) Filed: Sep. 3, 2003

(51) Int. Cl. B41J 2/435

(52) U.S. Cl. 347/227

(57) ABSTRACT

A compact material marking system and method uses a laser to mark materials such as fabrics in environments such as stores with safety and ease of use being addressed. The system includes a housing containing the laser, gas filters, and other equipment such as fans. Material to be marked is placed into a cassette box having an opening exposing the material. The cassette is engaged with an enclosure that is coupled to the housing to allow the laser beam from the laser to enter the enclosure and to strike the material found in the engaged cassette. Fumes caused by interaction of the laser beam with the material are contained by the enclosure and drawn away to be filtered. Sensors are employed so that the laser can be activated only when the cassette is fully engaged with the enclosure.

### BACKGROUND OF THE INVENTION

1. Field of the Invention

The present invention is directed generally to systems for marking materials and, more particularly, to laser systems for marking materials.

2. Description of the Related Art

Laser-based marking systems and methods for marking materials such as fabrics are conventionally known. In certain areas of the fashion industry, these conventional systems are widely used by manufacturing companies to mark clothing such as denim jackets and jeans.

Unfortunately, these conventional laser-based marking systems are designed with certain degrees of safety, operational complexity, and size in mind such that their use is confined to restricted areas by trained operators.

### BRIEF SUMMARY OF THE INVENTION

The present invention resides in a compact material marking system. Embodiments include a system having a laser configured to emit a laser beam and a surface configured to receive a material to be struck by the laser beam. An enclosure is coupled to the laser. The enclosure is shaped and positioned with respect to the surface to contain fumes produced when the laser beam strikes the material and to prevent injury from the laser beam. A filter is configured for filtering gases produced when the laser beam strikes the material. A fan is configured to produce fluid flow to cause the fumes contained by the enclosure to flow from the enclosure through the filter.

Further embodiments include a box configured to contain the material, the box having a box opening to expose the material. The box is shaped to engage the enclosure to align at least a portion of the box opening with at least a portion of an enclosure opening to allow the laser beam to enter the box opening and strike the material in the box.

Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a front isometric view showing an implementation of a compact material marking system.

FIG. 2 is a rear isometric view showing the compact material marking system of FIG. 1.

FIG. 3 is an isometric view showing the material cassette of the compact material marking system of FIG. 1.

FIG. 4 is a top plan view of the material cassette shown in FIG. 3 (shown with an open cover).

FIG. 5 is a side elevational view of the open material cassette shown in FIG. 4.

FIG. 6 is a cross-sectional side elevational view of the material cassette taken substantially along the line 6-6 of FIG. 4.

FIG. 7 is an isometric bottom view of the material cassette of FIG. 3 showing guide grooves on the bottom of the material cassette.

FIG. 8 is a cross-sectional side elevational view of the material cassette taken substantially along the line 8-8 of FIG. 4.

FIG. 9 is a cross-sectional side elevational view of the material cassette of FIG. 3 with a closed cover.

FIG. 10 is a cross-sectional side elevational view of the open material cassette of FIG. 3 showing placement of a piece of material within the box of material cassette.

FIG. 11 is a cross-sectional side elevational view of the material cassette of FIG. 3 with the piece of material as shown in FIG. 10 with the cover closed.

FIG. 12 is an isometric view of the closed material cassette of FIG. 3 with the piece of material inside.

FIG. 13 is an isometric view of the compact material marking system of FIG. 1 showing the insertion orientation of the material cassette with respect to guides on a cassette platform.

FIG. 14 is an isometric view of the compact material marking system of FIG. 1 with the piece of material in the material cassette.

FIG. 15 is a schematic cross-sectional view of the compact material marking system taken along the line 15-15 of FIG. 14 showing initial insertion of the material cassette into a receiving area of the compact material marking system.

FIG. 16 is a schematic cross-sectional view of the compact material marking system taken along the line 16-16 of FIG. 14 showing intermediate insertion of the material cassette into the receiving area of the compact material marking system.

FIG. 17 is a cross-sectional view of the compact material marking system taken along the line 17-17 of FIG. 14 showing final insertion of the material cassette into the receiving area of the compact material marking system.

FIG. 18 is a representative graph of signal levels received by the intermediate sensor of the compact material marking system of FIG. 1 during insertion of the material cassette into the receiving area of the compact material marking system.

FIG. 19 is a schematic cross-sectional view of the compact material marking system taken along the line 19-19 of FIG. 14 showing airflow patterns during operation of the compact material marking system.

FIG. 20 is a front elevational view of the compact material marking system of FIG. 1 showing airflow patterns during operation the compact material marking system.

FIG. 21 is a schematic cross-sectional view of an alternative implementation with the same external appearance as the compact material marking system shown in FIG. 14 with the cross-sectional view taken along the line 21-21 of FIG. 14 showing airflow patterns during operation of the alternative implementation.

### DETAILED DESCRIPTION OF THE INVENTION

As will be discussed in greater detail below, a compact material marking system disclosed herein can be used to mark materials in a variety of operational settings by relatively unskilled users. Both safety and environmental quality issues associated with operation are addressed and thereby allows operation by persons such as customers in locations such as stores. Consequently, the existing scope of possible application and implementation of laser-based marking can be greatly expanded.

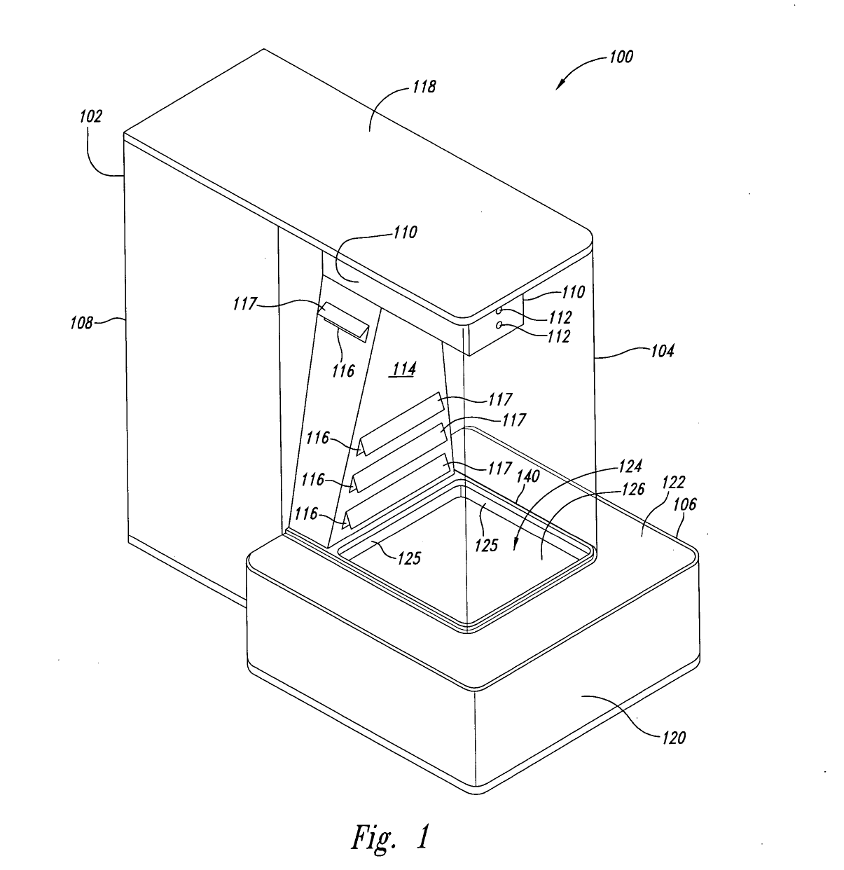

An implementation of the compact material marking system according to the present invention is shown in FIG. 1 as a marking system 100 having a housing 102, an enclosure 104 (typically transparent but opaque to laser wavelengths used) and a material cassette 106. The housing 102 includes an equipment container 108 to house devices for generating a laser beam and handling noxious fumes generated as described further below. The housing 102 also includes a laser beam container 110 that houses mirrors and other devices to direct the generated laser beam. Status indicators 112 are positioned on the laser beam container 110 to inform users of operational status such as when the material cassette 106 has been properly positioned for operation, when the marking system 100 has been turned on, when the marking system is in operation, and when the marking system has finished processing a piece of material. The housing 102 further includes vapor ducting 114 having intake scoops 116 with deflectors 117 to collect noxious fumes produced during operation. A top 118 seals top portions of both the equipment container 108 and the enclosure 104.

The material cassette 106 has a box 120 with a cover 122. The cover 122 has an opening 124 that exposes the material to be treated that is contained within the material cassette 106 as discussed further below. Furthermore, the opening 124 is defined by opening walls 125 that help both define the opening and secure the material to be treated that has been placed on a fabric platform 126, positioned below the opening. The fabric platform 126 is a part of the material cassette 106. In some implementations, the opening walls 125 are approximately one-half an inch in size to allow for fabric that has items attached, such as buttons, to be inserted under the enclosure 104 as discussed further below.

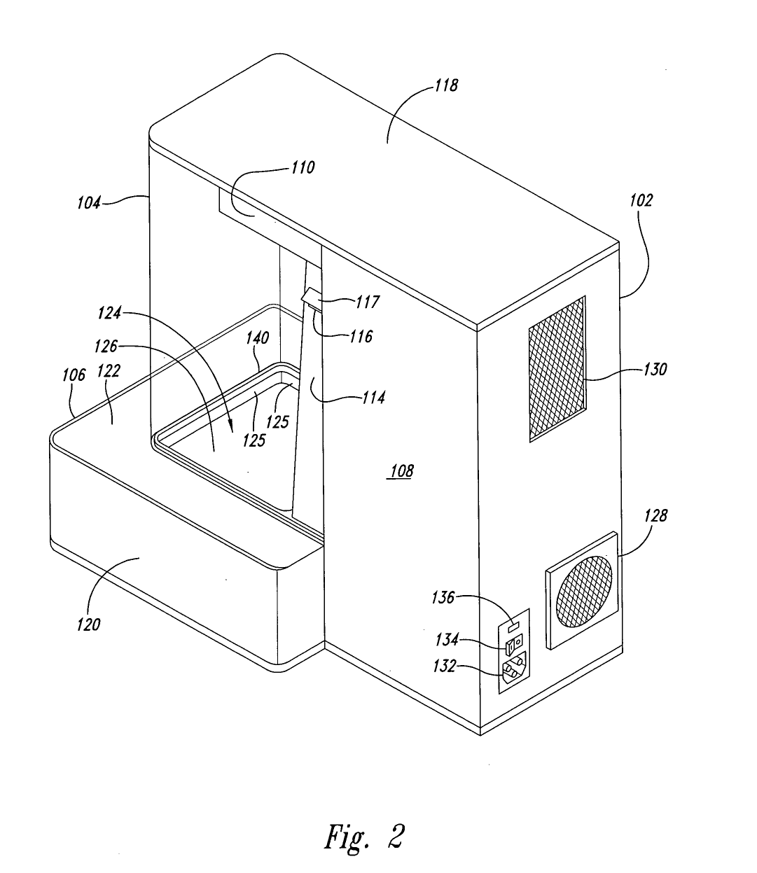

As shown in FIG. 2, the equipment container 108 of the housing 102 further includes an intake fan 128 to push air into the interior of the equipment container and an exhaust fan 130 to expel air from the interior of the equipment container. Also located on the equipment container 108 is a power cord coupler 132 to receive a power cord (not shown), a power switch 134 to control power to the material marking system 100, and a power indicator 136 to indicate when power is available to the material marking system.

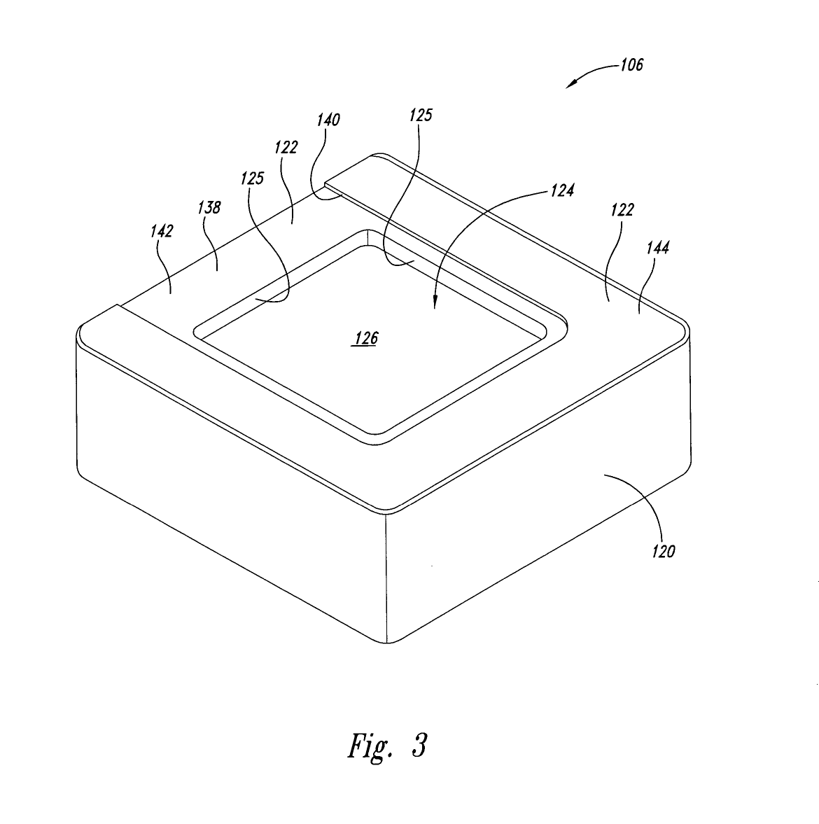

As shown in FIG. 3, the material cassette 106 further includes a channel 138 with channel walls 140, a channel surface 142, and an upper exterior cover surface 144 of the cover 122 that allow the material cassette to be slid into a receiving area underneath the enclosure 104. Other implementations use an enclosure that has walls extending downward to meet a base with an opening in one of the walls of the enclosure to slidably accept a material cassette. In the depicted implementation, the material cassette 106 can be larger than a material cassette configured for insertion into an opening in a wall of the enclosure and thus could contain more material. When the material cassette 106 is slid into position underneath the enclosure 104, the channel walls 140 are substantially adjacent to a lower end portion of the enclosure as best shown in FIGS. 1 and 2.

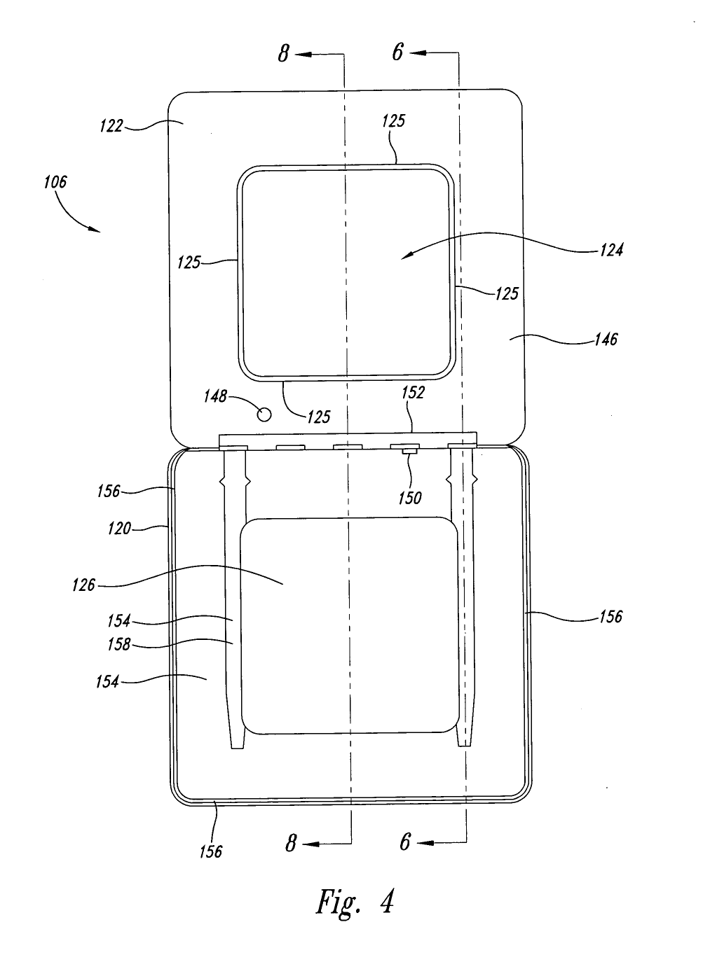

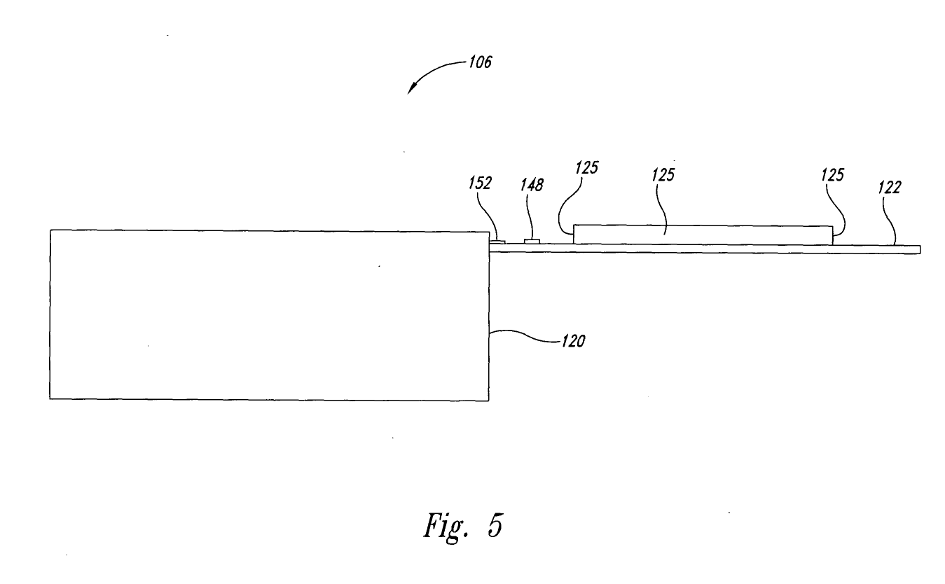

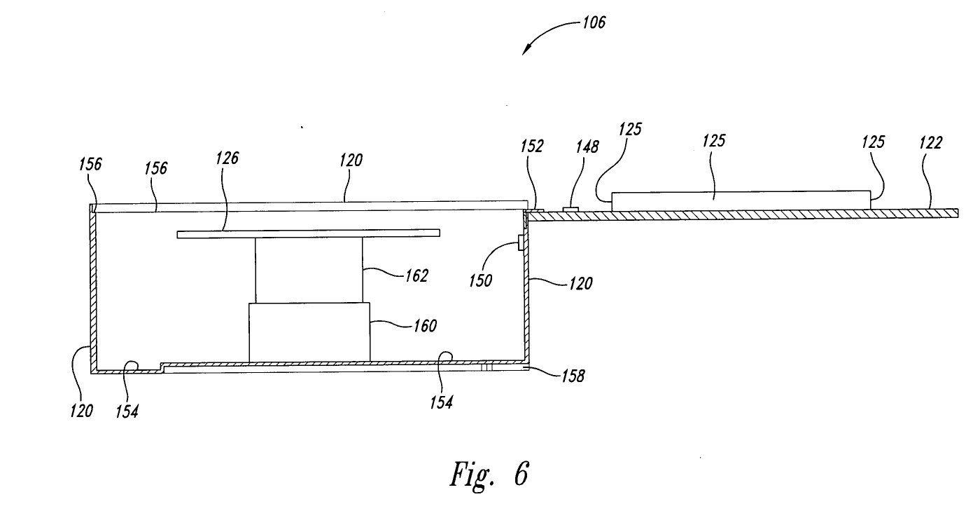

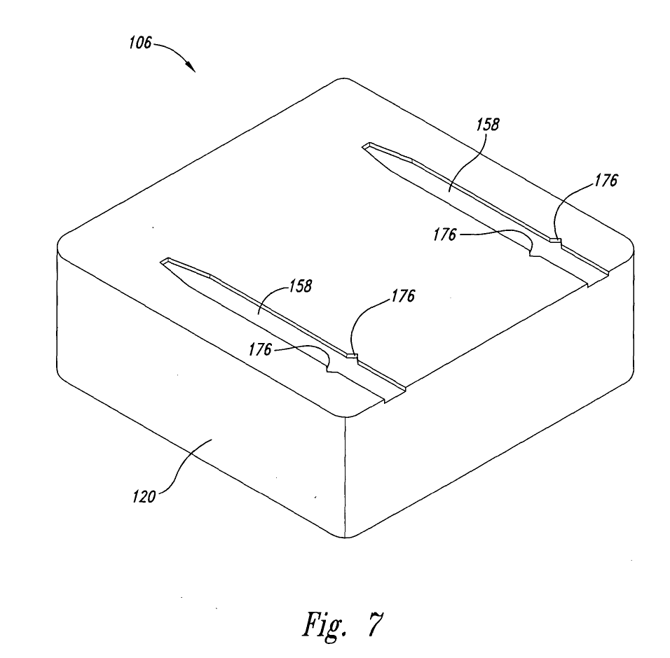

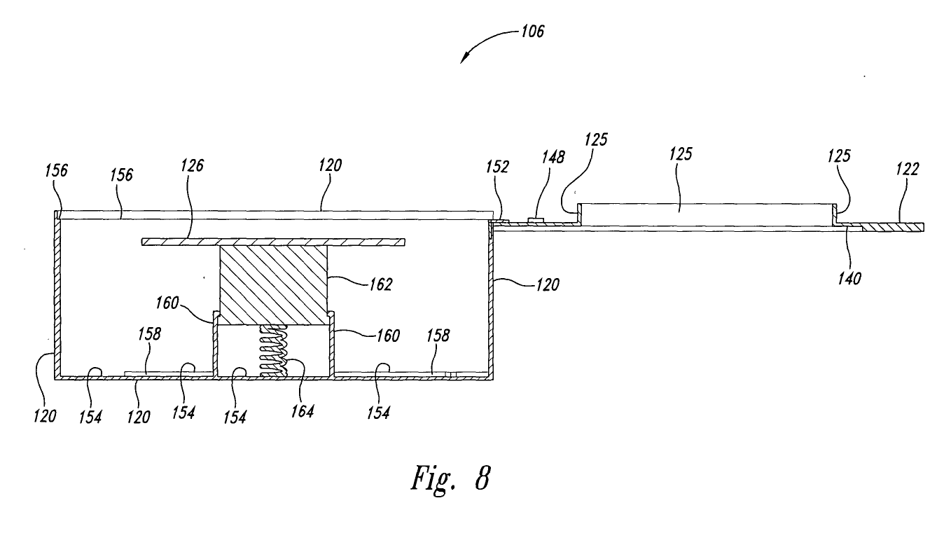

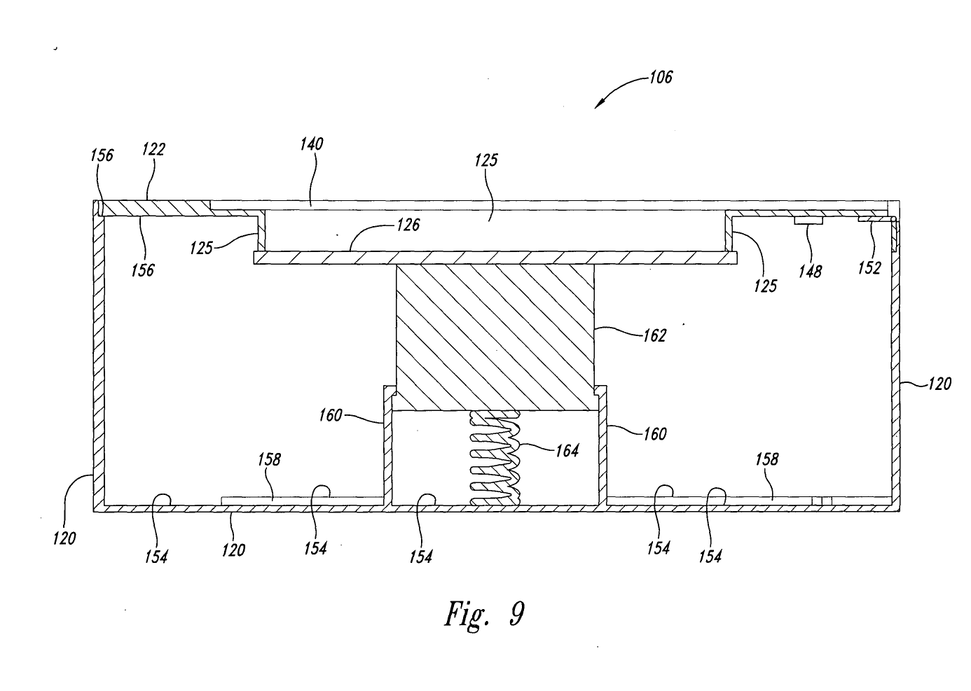

Interior aspects of the material cassette 106 are shown in FIGS. 4-6, 8, and 9 showing the cover 122 being in the open position. The cover 122 has an interior cover surface 146 upon which an intermediate magnet 148 is fastened. A final magnet 150 is fastened to an interior wall surface of the box 120. The cover 122 is coupled to the box 120 by a hinge 152. The box 120 also has an interior lower box surface 154 to which the fabric platform 126 is coupled. A lip 156 extends from interior wall surfaces of the box 120 near to the top of the box as best shown in FIG. 6 to provide support for the cover 122 when the cover is closed. As further explained below, a pair of guide grooves 158, best shown in FIG. 7, are fashioned in the bottom external surface of the box 120 to assist in insertion of the material cassette 106 into the receiving area underneath the enclosure 104 of the marking system 100. The fabric platform 126 is attached to a base 162, which is further attached to a spring 164 as shown in FIG. 8. The spring 164 is attached to the interior lower box surface 154 of the box 120 and is enclosed by a spring enclosure 160. The spring enclosure 160 also retains the base 162 to limit its upward movement. As shown in FIG. 9, in its closed position, the cover 122 rests upon the lip 156.

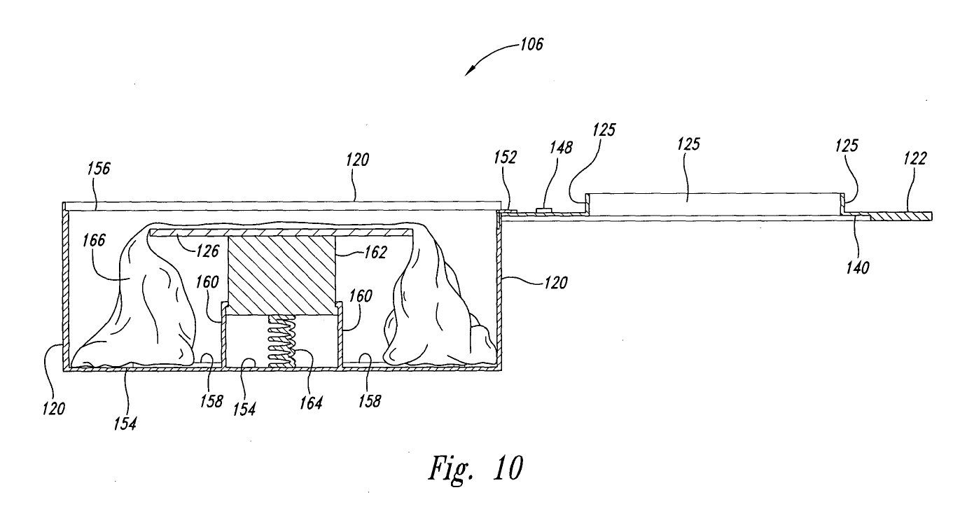

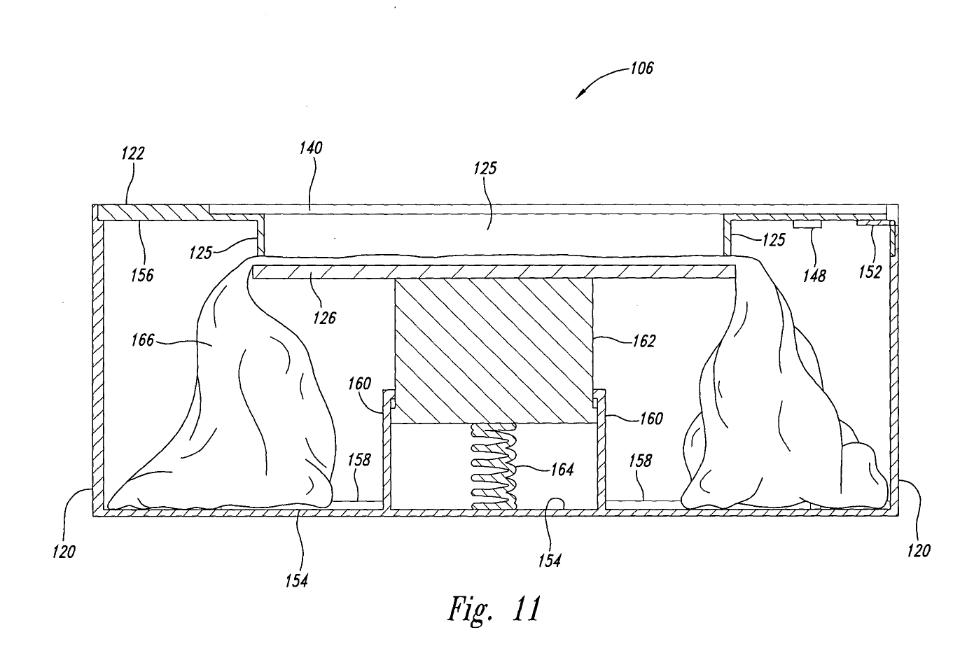

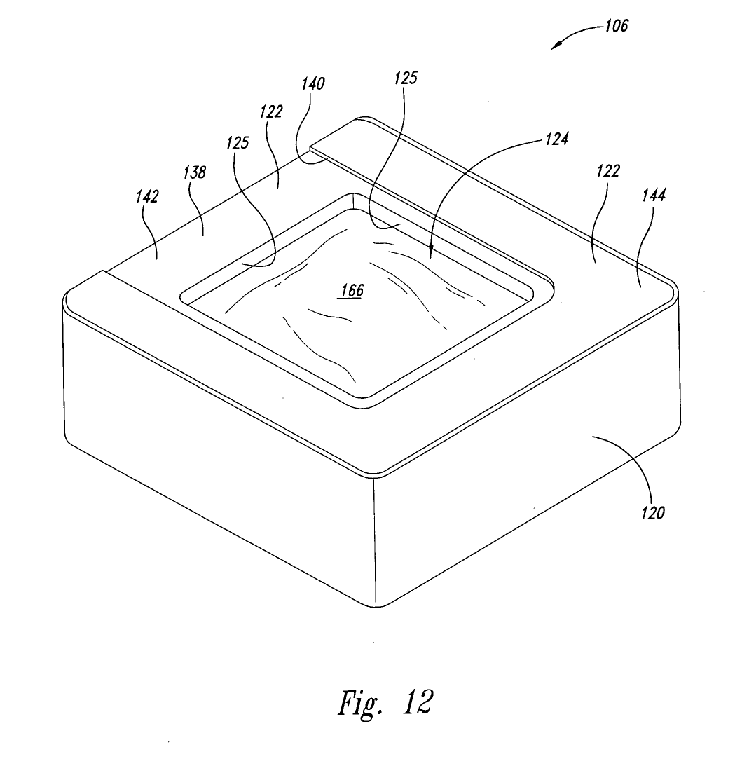

To use the material cassette 106, the cover 122 is first opened and a portion of a fabric 166, such as a piece of cloth, an article of clothing, or other such fabric item to be marked is placed upon the fabric platform 126 so that the fabric portion lies flat upon the fabric platform as shown in FIG. 10. The cover 122 is then closed so that the opening walls 125 press down onto a portion of the fabric 166 that is lying flat upon the fabric platform 126 near the edges of the fabric platform as shown in FIG. 11. The spring 164 biases the fabric platform 126 upward to maintain the fabric 166 thereon in contact with the opening walls 125. That portion of the fabric 166 lying flat on the fabric platform 126 can be seen through the opening 124 of the material cassette 106 as shown in FIG. 12.

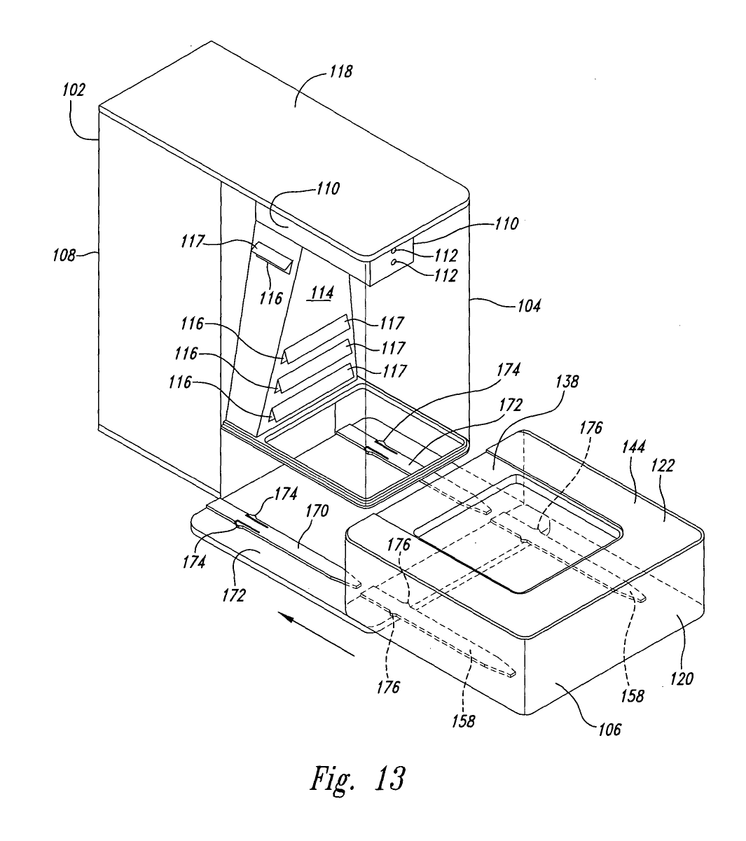

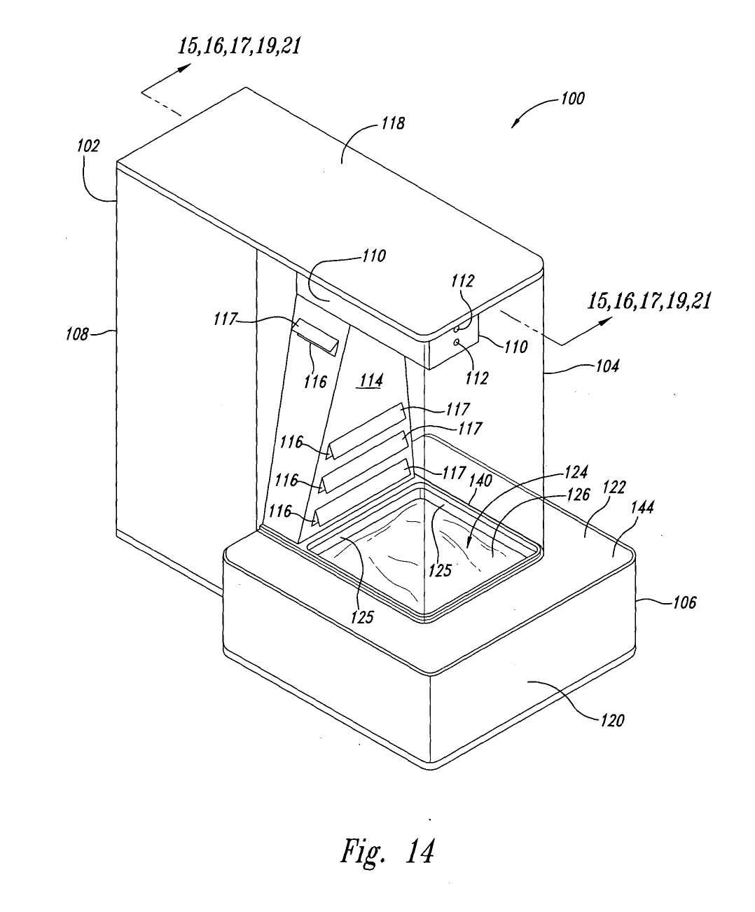

To insert the material cassette 106 into the receiving area of the marking system 100 underneath the enclosure 104, the guide grooves 158 are aligned with a pair of guides 170 on a cassette support platform 172 fixedly attached to the equipment container 108 of the housing 102 underneath the enclosure 104, as shown in FIG. 13. By aligning the guide grooves 158 with the guides 170, the channel 138 is also aligned with the lower end portion of the enclosure 104 to allow insertion of the material cassette 106. The guides 170 have tabs 174 that mate with notches 176 found in each of the guide grooves 158 when the material cassette 106 is fully inserted into the receiving area of the marking system 100. When the material cassette 106 contains the fabric 166 and is fully inserted as shown FIG. 14, the marking system 100 is ready for powered operation.

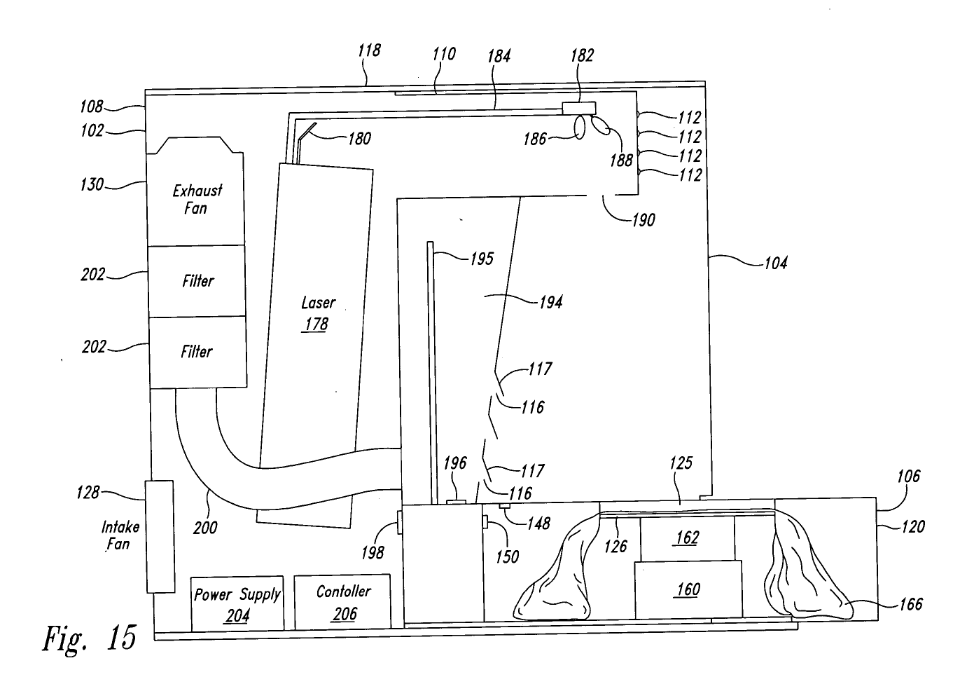

Internal components of the marking system 100 are shown in the cross-sectional view of FIG. 15 taken along the 15-15 line and of FIG. 14. The equipment container 108 houses a laser 178 with an implementation having a predominantly vertical orientation for the laser. An angled mirror 180 is positioned to reflect a laser beam emitted from the laser 178 to redirect the beam into a substantially horizontal orientation. The horizontally oriented laser beam travels within the laser beam container 110 to strike an x-axis mirror 186 and a y-axis mirror 188 which have their orientation controlled by an optical scanner 182 that is held in position by a mount 184.

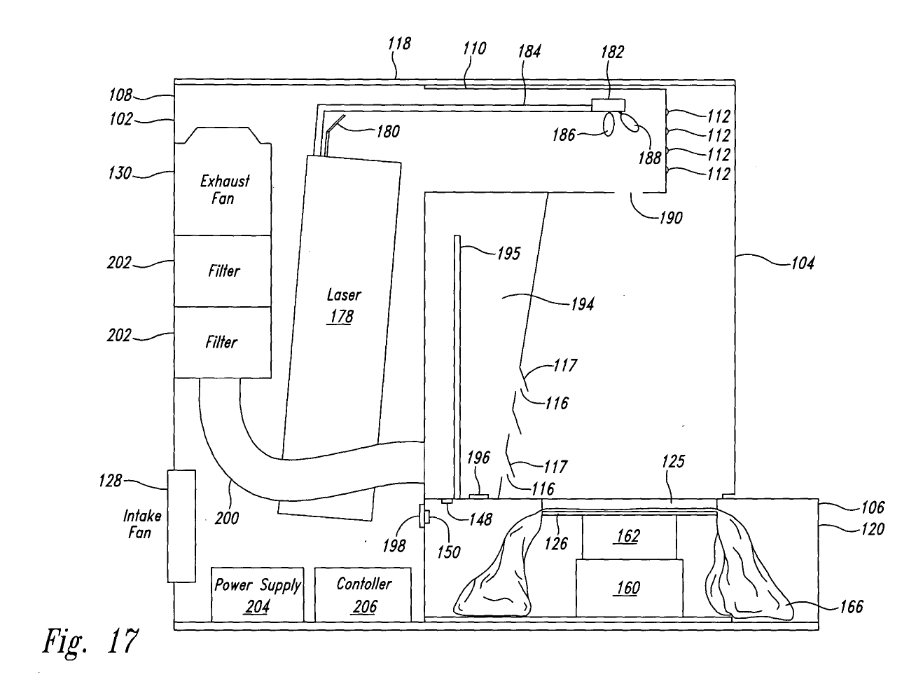

Once the horizontally oriented laser beam strikes a combination of the x-axis mirror 186 and the y-axis mirror 188, it is redirected through an aperture 190 to strike a desired spot on the fabric 166 depending upon orientation of the mirrors when the material cassette 106 is fully inserted into the receiving area as shown in FIGS. 14 and 17. When the fabric 166 is treated by the laser 178 a certain amount of fumes result, which pass through the intake scoops 116 into a plenum 194. A divider 195 within the plenum 194 allows a certain air flow pattern discussed further below to assist intake of the fumes by the scoops 116.

A duct 200 is located within the equipment container 108 to convey fumes from the plenum 194 through two filters 202 as drawn by the exhaust fan 130 to be sent into the exterior atmosphere. In some implementations, the filters 202 include activated charcoal to capture some of the gases that make up the fumes emitted from the fabric 166 during operation of the marking system 100.

Also located in the equipment container 108 is a power supply 204 to furnish power and a controller 206 to furnish control functions to components within the equipment container.

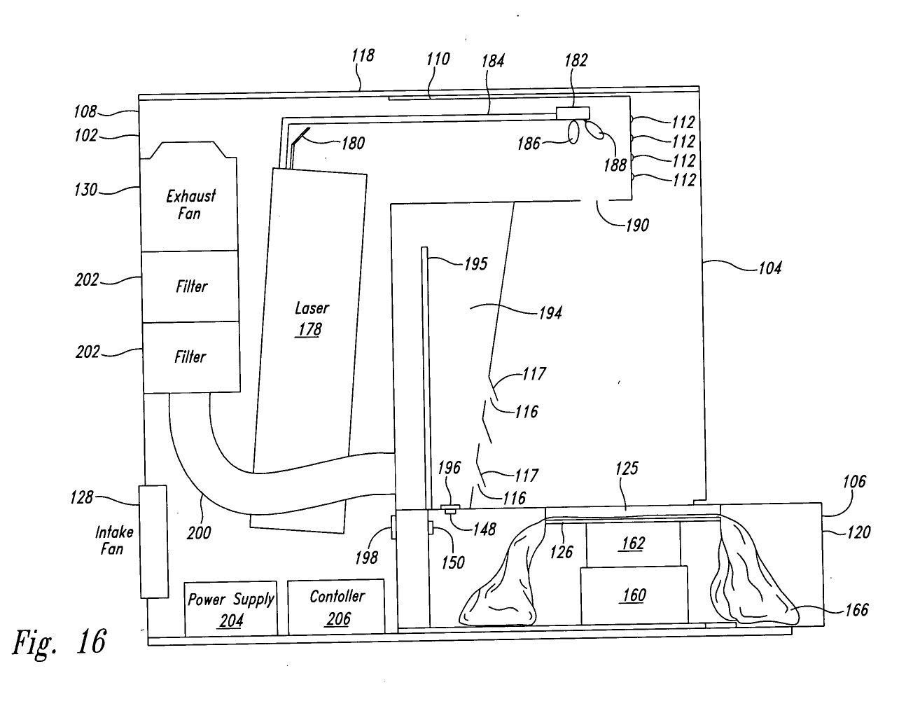

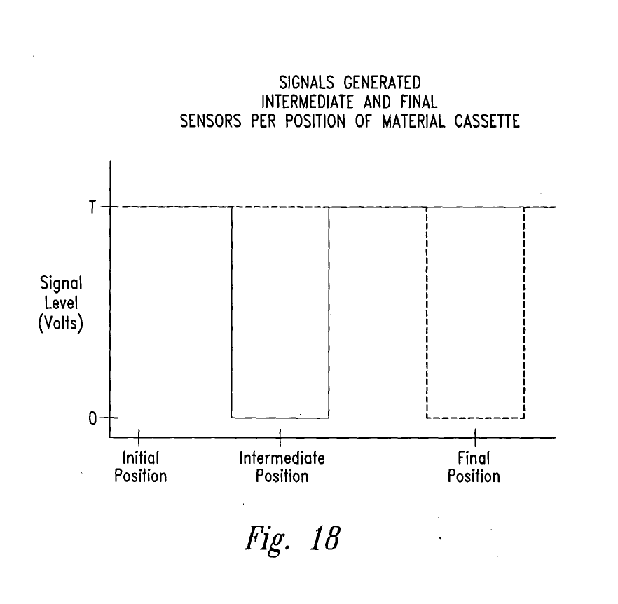

Located in the bottom floor of the plenum 194 is an intermediate magnetic sensor 196 positioned to determine when the material cassette 106 has reached an intermediate position prior to its operational position by generating a signal when the intermediate magnet 148 has come into close proximity to the intermediate sensor. The material cassette 106 is shown in FIG. 15 inserted to a certain extent into the rest of the marking system 100 less than the intermediate position. In FIG. 16, the material cassette 106 is shown inserted to the intermediate position whereat the intermediate magnet 148 is directly below the intermediate sensor 196. In FIG. 17, the material cassette 106 is shown inserted to a final position whereat the final magnet 150 is adjacent to a final magnetic sensor 198 and the intermediate magnet 148 has passed by the intermediate sensor 196 and is positioned further inward toward the equipment container 108. As the intermediate magnet 148 nears the vicinity of the intermediate sensor 196 and the final magnet 150 nears the vicinity of the final sensor 198, respectively, the voltage levels of the signals generated by the intermediate sensor and the final sensor increase as shown in FIG. 18.

The signals generated by the intermediate sensor 196 and the final sensor 198 are used in a safety lockout feature which prevents the marking system 100 from being activated unless the material cassette 106 has been properly inserted into the rest of the marking system. In particular, as shown in FIG. 18, as the material cassette 106 is inserted into the marking system 100, the signal generated by the intermediate sensor 196 starts at a substantially zero voltage level, rises to a maximum voltage level, and then decreases back to the substantially zero voltage level. As the material cassette 106 is inserted into the marking system 100, the signal generated by the final sensor 198 starts at a substantially zero voltage level and finally rises to a maximum voltage level. The controller 206 is programmed to prevent activation of the marking system 100 unless these signal generation characteristics of the intermediate sensor 196 and the final sensor 198 with respect to insertion of the material cassette 106 into the marking system 100 are recognized by the controller. Consequently, the marking system 100 cannot be activated unless the material cassette 106 has been properly inserted into the marking system.

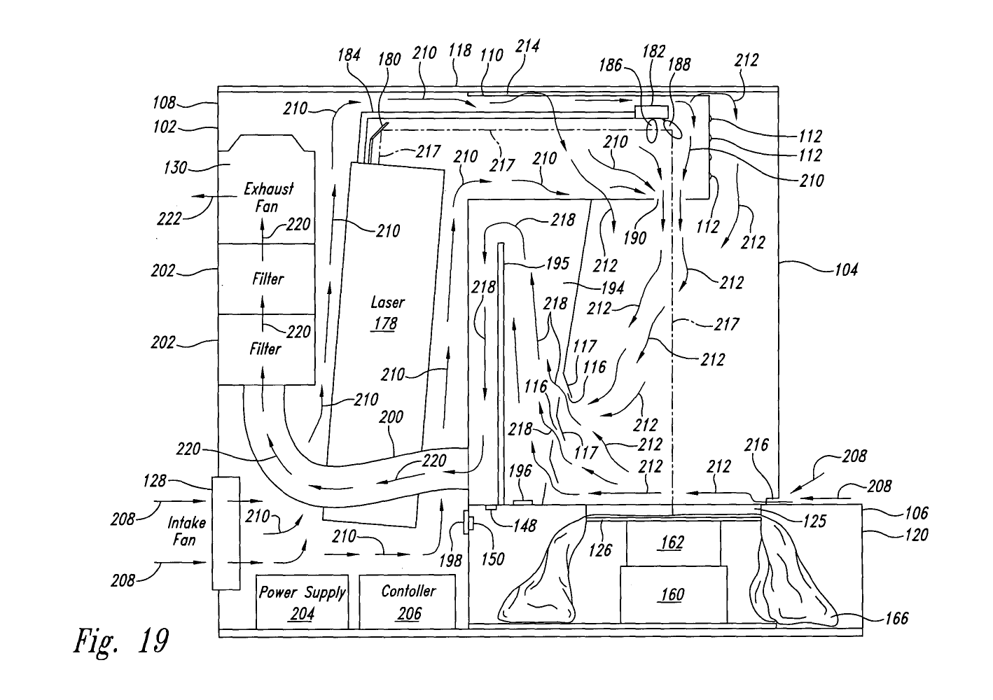

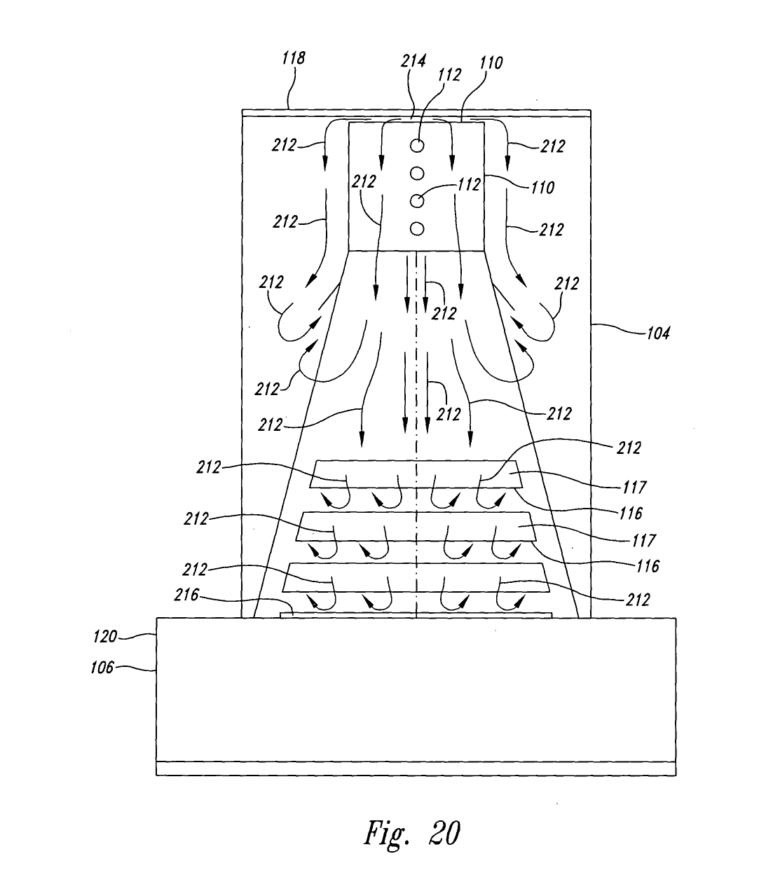

Fluid flow patterns associated with the marking system 100 are depicted in FIGS. 19 and 20 showing outside air 208 being brought into the marking system through the intake fan 128 to become housing air 210 that flows from the bottom of the equipment container 108 along external surfaces of the laser 178 thereby assisting in laser cooling, and through the laser beam container 110 to flow through the aperture into the enclosure 104 as enclosure air 212. Other of the housing air 210 flows through a housing gap 214 between the top 118 and the laser beam container 110 into the enclosure 104 to also become enclosure air 212.

Other outside air 208 flows into the enclosure 104 to become enclosure air 212 through an enclosure gap 216 between the enclosure 104 and the material cassette 106, which helps to keep the material 166 flattened upon the fabric platform 126. These various sources of enclosure air 212 allow for proper mixing and flow of enclosure air to assist in carrying any fumes created by the laser beam indicated by reference numeral 217 in FIG. 19, striking the fabric 166 to be carried through the intake scoops 116 along with the enclosure air 212 into the plenum 194 to become plenum air 218. From the plenum 194, the plenum air 218 flows into the duct 200 to become duct air 220. The duct air 220 flows through the filters 202 and the exhaust fan 130 to be vented externally from the marking system 100 as exhaust air 222.

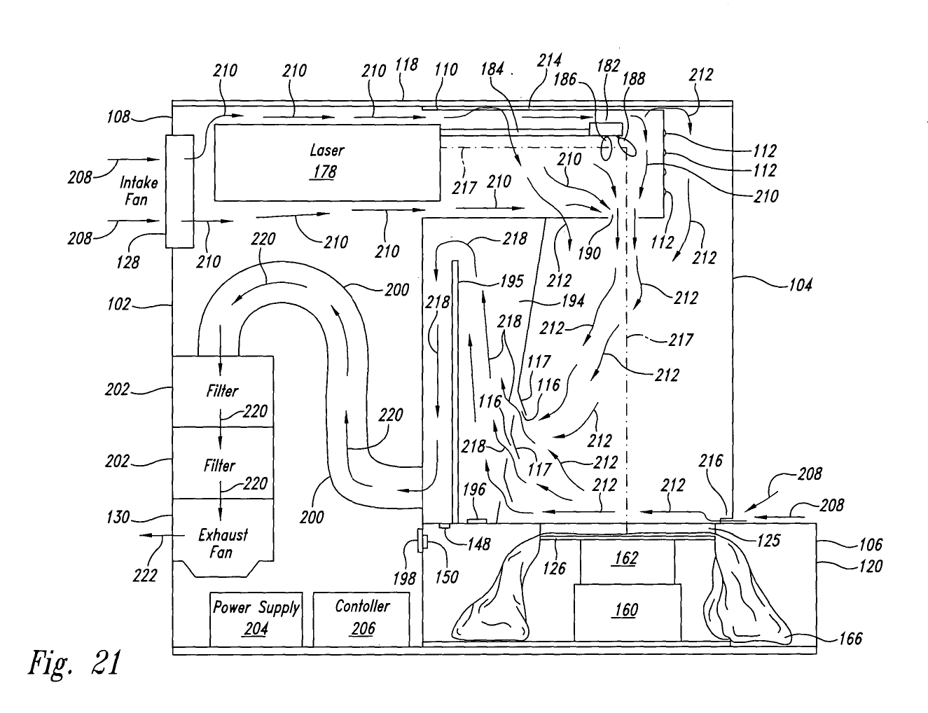

In an alternative implementation shown in FIG. 21, the laser 178 is positioned in a substantially horizontal orientation allowing for the laser beam 217 to exit horizontally thereby eliminating the need for the mirror 180. In this alternative implementation other components of the equipment container 108 have been rearranged to allow for the alternative placement of the laser 178.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system comprising:
a laser configured to emit a laser beam;
a surface configured to receive a material to be struck by the laser beam;
an enclosure coupled to the laser, the enclosure shaped and positioned with respect to the surface to contain fumes produced when the laser beam strikes the material;
a filter configured for filtering gases produced when the laser beam strikes the material; and
a fan configured to produce fluid flow to cause the fumes contained by the enclosure to flow from the enclosure through the filter.

2. The system of claim 1 wherein the surface is configured to receive a fabric as the material.

3. The system of claim 1 wherein the surface is of a spring-loaded platform.

4. A system comprising:
a housing;
a laser contained within the housing, the laser configured to emit a laser beam;
a fan positioned to direct air from outside of the housing into the housing to become housing air to flow adjacent to the laser;
an enclosure coupled to the housing;
a opening between the housing and the enclosure to allow the laser beam to enter the enclosure to strike a material thereby creating fumes within the enclosure and to allow at least a portion of the housing air to flow into the enclosure to become enclosure air; and
a plenum positioned within the enclosure and coupled to the housing, the plenum having scoops to receive the enclosure air into the plenum to become plenum air, the enclosure shaped to restrict the fumes from exiting the system without first passing into the plenum.

5. The system of claim 4 further comprising a filter coupled to the plenum to filter plenum air.

6. The system of claim 4 wherein the scoops of the plenum are vertically arranged along surfaces of the plenum.

7. The system of claim 4 wherein the enclosure is transparent to light having wavelengths other than that of light produced by the laser.

8. The system of claim 4 wherein the second opening is a gap between the enclosure and the housing.

9. A system comprising:
a laser configured to emit a laser beam;
a box configured to contain a material, the box having a box opening to expose the material; and
an enclosure coupled to the laser, the enclosure having a first opening to receive at least a portion of the box to position the box opening inside of the enclosure to allow the laser beam to enter the box opening and strike the material in the box.

10. A system comprising:
a laser configured to emit a laser beam;
a box configured to contain a material, the box having a box opening to expose the material; and
an enclosure coupled to the laser, the enclosure having an opening, the box shaped to engage the enclosure to align at least a portion of the box opening with at least a portion of the enclosure opening to allow the laser beam to enter the box opening and strike the material in the box.

11. The system of claim 10 wherein the enclosure has another opening to receive the laser beam when the laser beam is emitted from the laser.

12. The system of claim 10 wherein the box has a channel shaped to mate with a wall of the enclosure for engagement of the box with the enclosure to contain fumes produced when the laser beam strikes the material.

13. The system of claim 10 further including a spring loaded platform coupled to the box inside of the box, aligned with the box opening, and sized to receive a portion of the material to be struck by the laser thereon.

14. A system comprising:
a laser configured to emit a laser beam;
a box configured to contain a material, the box including a box opening to expose the material;
an enclosure coupled to the laser, the enclosure having an enclosure opening, the enclosure and the box shaped to allow for engagement of the box with the enclosure from an initial engagement position of the box to a final engagement position of the box, in the final engagement position, the box being positioned to allow the laser beam to enter the box opening;
a magnet affixed to the box; and
a magnetic sensor coupled to the enclosure to sense the magnet to determine a designated engagement position of the box with the enclosure.

15. The system of claim 14 further including a controller configured to prevent emission of the laser beam by the laser unless the box is in the designated engagement position with the enclosure.

16. The system of claim 14 further including a second magnetic sensor coupled to the enclosure to sense another magnet affixed to the box to determine a second designated engagement position of the box with the enclosure.

17. A method of marking a material with a laser beam:
placing the material in a box with an opening;
engaging the box with an enclosure;
directing the laser beam through the opening of the box onto the material; and
containing gases within the enclosure that are introduced into air inside the enclosure by the laser beam striking the material within the enclosure.

18. The method of claim 17 further including directing the gases generated by the laser and contained by the enclosure through a filter to filter out at least some of the gases from the enclosure air.

19. The method of claim 17 further including exhausting a portion of the enclosure air from the enclosure after at least some of the gases have been filtered out of the enclosure air.

20. A method of marking a fabric with a laser beam:
laying a portion of the fabric flat against a spring loaded platform mounted in a box;
closing a cover of the box to press against at least some of the fabric portion, the cover having an opening;
engaging the box with an enclosure with the cover opening aligned to be struck by the laser beam; and
directing the laser beam through the cover opening onto the material.

21. A method of marking a material with a laser beam:
enclosing a portion of a material with an enclosure;
directing the laser beam onto the material thereby creating fumes within the enclosure; and
drawing fumes from the enclosure through a filter.

22. A method of marking a material with a laser beam:
placing the material into a box;
engaging the box with an enclosure to a first positional degree;
electronically sensing the first positional degree of engagement of the box with the enclosure;
engaging the box with the enclosure to a second positional degree;
electronically sensing the second positional degree of engagement of the box with the enclosure; and
activating a laser to produce the laser beam on the condition of occurrence of the electronically sensing the first and second positional degrees of engagement of the box with the enclosure.

23. A system comprising:
a laser configured to emit a laser beam;
a box configured to contain a material to be struck by the laser beam, the box having a box opening to expose the material;
an enclosure coupled to the laser, the enclosure having an enclosure opening, the enclosure and the box shaped to allow for engagement of the box with the enclosure from an initial engagement position of the box to a final engagement position of the box, in the final engagement position, the box being positioned to allow the laser beam to enter the box opening, the enclosure shaped and positioned with respect to the box to contain fumes produced when the laser beam strikes the material;
a filter configured for filtering gases produced when the laser beam strikes the material;
a fan configured to produce fluid flow to cause the fumes contained by the enclosure to flow from the enclosure through the filter;
a magnet affixed to the box; and
a magnetic sensor coupled to the enclosure to sense the magnet to determine a designated engagement position of the box with the enclosure.
